(19) United States
(12) Patent Application Publication
(10) Pub. No.: US 2010/0238360 A1
(43) Pub. Date: Sep. 23, 2010

(54) RADIO TUNING DEVICE THROUGH A CABLE

(76) Inventor: Chien-Chung LEE, Jhonghe City (TW)

Correspondence Address: Muncy, Geissler, Olds & Lowe, PLLC, 4000 Legato Road, Suite 310, FAIRFAX, VA, 22033, US

(21) Appl. No.: 12/407,331

(22) Filed: Mar. 19, 2009

(51) Int. Cl. H04N 5/50

(52) U.S. Cl. 348/731; 348/E05.097

(57) ABSTRACT

A radio tuning device through a cable includes an emitter and receivers. The emitter can be embedded in a wall and includes first tuning units. Each receiver is an advanced TV tuner to replace an original TV tuner; as a digital broadcast TV received by an original TV set through the TV tuner, an analog or digital TV from cables, and even an interactive digital TV are received through cables or wirelessly. Each receiver further contains a second tuning unit which can be combined with various computer interfaces or displayer interfaces, e.g. USB, PCMCIA, DVI, VGA or HDMI. The first and second tuning units are applied to a digital or analog interface, and are very highly compatible. Accordingly, the cable TV can be watched by wireless transmission without cabling in a room, which is pretty, saves time and labor work and allows cable channels to be watched on the computers.

### BACKGROUND OF THE INVENTION

a) Field of the Invention

The present invention relates to a radio tuning device, and more particularly to a radio tuning device through a cable which utilizes a wireless transmission method to convert cable TV (television) signals into radio signals, without having trouble in pulling cables while installing the cable TV.

b) Description of the Prior Art

A contemporary person is very cautious about work attitude. In this highly competitive era, each person is jittery to face one's own work, thus often resulting in pity due to too much work pressure. Accordingly, to resolve this trouble of most working people, watching a TV can be a good way to depressurize the working people who are under stress of work. A variety show or a tour channel in TV programs can sooth the person who watches the TV to relax one's body.

Although the TV programs can make the people feel comfortable, there are only few TV stations in old times. As these TV stations are wireless television stations, an antenna must be set up to watch the channels, and the antenna should be adjusted to an angle that receiving can be clear. If in a typhoon day, the antenna can be blown away by wind easily; this can be very dangerous. In addition, as there are only few TV channels, choices are very few and not all viewers can be satisfied. Therefore, a cable TV arises. There are great deals of cable channels and each cable station will have its own dedicated programs. One can view the programs, such as sports, variety shows, news and local channels, by just adding a Set-Top box and with cable pulling, allowing the viewers to have more choices to their favorite channels.

However, in using the aforementioned cable TV, following issues and shortcomings actually exist to be improved:
1. Although the cable TV provides a lot of family entertainment effects, it is very troublesome in implementing the cable TV, as the cable should be pulled from outside to inside a house, until to a TV set. It has been already very trouble in cabling.
2. An advanced digital TV set is thin, light and large, and is usually hung on a wall. Therefore, an awkward coaxial cable at this time will be inconvenient and ugly.
3. If the TV set should be moved in a future, then the coaxial cable needs to be re-wired, which results in a lot of inconveniences.
4. If a cable TV needs to be expanded, then more splitters and coaxial cables should be purchased. In addition, it will even waste labor time to connect the TV cables from a main TV set to TV sets which are branched out.
5. If cable channels are to be watched on an ordinary computer, then a Set-Top box needs to be added, branching out from a main TV set should be done and cabling should be made as well, thereby causing trouble and occupying space.

Accordingly, how to solve the aforementioned issues and shortcomings of the prior art is to be studied and researched for improvement by the present inventor and related industries.

### SUMMARY OF THE INVENTION

The primary object of the present invention is to provide a radio tuning device through a cable, by which when installing a cable TV, there is no need to pull a cable and do wire layout everywhere in a room. The tuning device includes an emitter and at least one receiver. The emitter can be embedded in a wall and contains at least one first tuning unit, at least one frequency conversion unit and at least one signal amplification unit. The receiver is an advanced TV tuner by which a digital broadcast TV received by an original TV set, an analog TV and a digital TV from a cable, as well as even an interactive digital TV can all be received through a cable or wirelessly. Therefore, an existing TV tuner can be replaced, enabling a TV set to be added with a function of receiving all kinds of TV signals from the cables wirelessly. As this device is a TV tuner, its use is similar to that of the original TV tuner, it is very easily used by a TV board maker and it can be very inexpensive. The receiver can also be combined with various computer interfaces or displayer interfaces, such as an USB (Universal Serial Bus) interface, a PCMCIA (Personal Computer Memory Card International Association) interface, a DVI (Digital Video Interface) interface, a VGA (Video Graphics Array) interface or an HDMI (High-Definition Multimedia Interface). At this time, this receiver can wirelessly receive a TV signal coming from the cable and convert into the computer or the displayer. The receiver is further provided with a second tuning unit. When a user is to use the tuning device, the signal will be filtered by the first tuning unit, followed by being up-converted by the frequency conversion unit. Due to wireless transmission, the frequency is definitely up-converted to a channel that can be transmitted. The signal is next amplified by the signal amplification unit and then is emitted to the receiver. After being received by an antenna set of the receiver, the signal is down-converted through the second tuning unit in the receiver and then is performed with analog or digital demodulation according to features of the signal. When the user switches to a different channel, the receiver will transmit back the signal to the emitter that the channel can be switched. On the other hand, a control signal required by a digital cable TV set or a control signal that is transmitted back by a two-way interactive TV set can be also transmitted through the present invention. In an existing wire layout, a coaxial cable needs to be pulled to a TV set, and if expansion is required, then a splitter should be added and more coaxial cables should be connected to branched-out TV sets, which waste time, wages and materials, as well as occupy space. By the aforementioned technologies, many drawbacks existing in the conventional wire layout of the cable TV set can be improved, thereby achieving the practical progressiveness that time spent in pulling the cable is saved, cost of materials is saved, prettiness is available and the TV set can be moved conveniently, as it is no need to layout the coaxial cable.

Another object of the present invention is to provide a radio tuning device through a cable, wherein the tuning device can be applied on an analog interface or a digital interface to receive an analog or digital signal, thereby being provided with high compatibility. In addition, the tuning device includes an emitter and at least one receiver. The emitter contains at least one first tuning unit, the receiver is further provided with a second tuning unit, and the second tuning unit is further provided with at least one transmission connector. The transmission connector can be connected to an antenna or a coaxial cable. When the user selects a channel to some frequency, the second turning unit can be changed to wireless transmission. If the wireless transmission is malfunctioning, then the coaxial cable can be used instead. Accordingly, comparing with the prior art that the signal can only be received through the coaxial cable, the present invention provides a choice for receiving through the coaxial cable or wirelessly, along with being equipped with the function of transmitting back the signal, thereby having high practicability, saving cost and not occupying space.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

FIG. 2 shows a three-dimensional view of a preferred embodiment of the present invention.

FIG. 3 shows a block diagram of an emitter of the present invention.

FIG. 4 shows a schematic view of an implementation of a preferred embodiment of the present invention.

FIG. 4A shows a block diagram of a receiver of the present invention.

FIG. 5 shows a schematic view of an implementation of a first preferred embodiment of the present invention.

FIG. 6 shows a schematic view of an implementation of a second preferred embodiment of the present invention.

FIG. 7 shows a block diagram of an external receiver of the present invention.

FIG. 8 shows a schematic view of an implementation of a third preferred embodiment of the present invention.

FIG. 9 shows a schematic view of an implementation of a fourth preferred embodiment of the present invention.

FIG. 10 shows a schematic view of an implementation of a fifth preferred embodiment of the present invention.

FIG. 11 shows a schematic view of an implementation of a sixth preferred embodiment of the present invention.

FIG. 12 shows a schematic view of an implementation of a seventh preferred embodiment of the present invention.

### DETAILED DESCRIPTION OF THE PREFERRED EMBODIMENTS

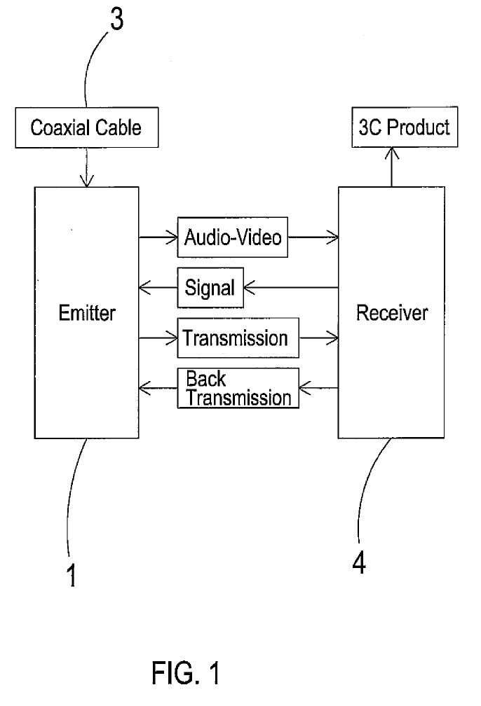

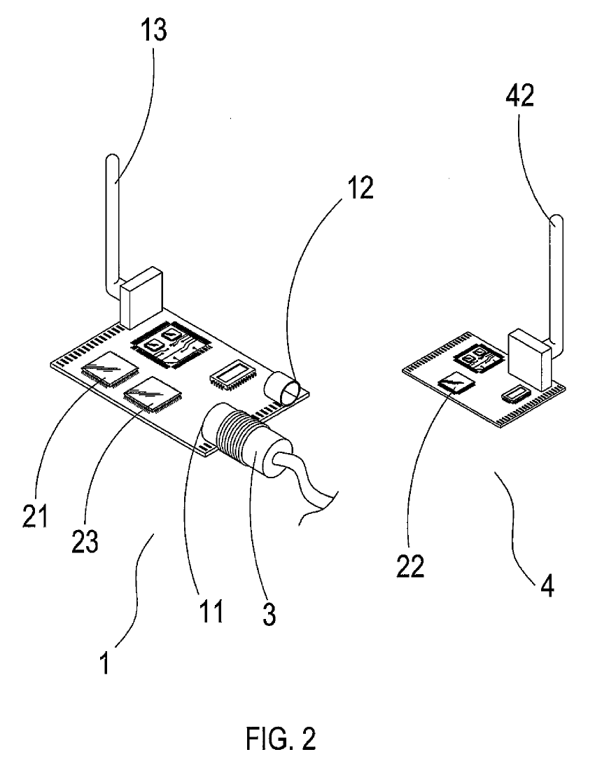

Referring to FIG. 1 and 2, it shows a block diagram and a three-dimensional view of a preferred embodiment of the present invention. The present invention comprises an emitter 1 and a receiver 4. The emitter 1 is connected with a coaxial cable 3 through an F-type connector 11, and contains a first tuning unit 21 and a frequency conversion unit 23. The first tuning unit 21 is provided with functions of selecting a frequency and retrieving out a signal. The receiver 4 can be electrically connected to a 3C product and is built into a control board of the 3C product that is provided with a display unit (such as a TV set). The receiver 4 can be further combined with various computer interfaces or displayer interfaces, such as a USB interface, a PCMCIA interface, a DVI interface, a VGA interface or an HDMI. Moreover, the receiver 4 can transmit a wireless control signal to the emitter 1 and is further provided with a second tuning unit 22. When a user is to watch a channel, he or she enters an instruction through a remote controller of the 3C (computer, communication, consumer electronics) product that is provided with a display unit (such as a TV set), and the control board of that 3C product will transmit a channel control signal to the receiver 4 through which the wireless control signal is emitted to the emitter 1. The emitter 1 will then filter the signal coming from the coaxial cable 3 through the first tuning unit 21, and take out the selected channel signal which is next up-converted or down-converted by the frequency conversion unit 23. As the signal needs to be transmitted wirelessly, the frequency of wireless carrier is chosen to a channel that is allowed to be transmitted, followed by being emitted to the receiver 4 to receive that frequency. In a mean time, the frequency is down-converted and is performed with digital or analog demodulation. Furthermore, the first tuning unit 21 and the second tuning unit 22 can be applied to a digital interface or an analog interface to receive a digital signal or an analog signal that more than one kind of signal can be received and content the signal carries will be the same as that from an original cable TV system. On the other hand, one side of the emitter 1 can be further provided with a power hole 12.

The emitter 1 and the receiver 4 are connected respectively with antenna sets 13, 42 that are used for emitting and receiving the signal. The antenna set is a dual band antenna, meaning that the antenna set can transmit or receive signals of two wireless bands. The antenna set is not limited to the configuration in the drawings and can be a hidden antenna, as well.

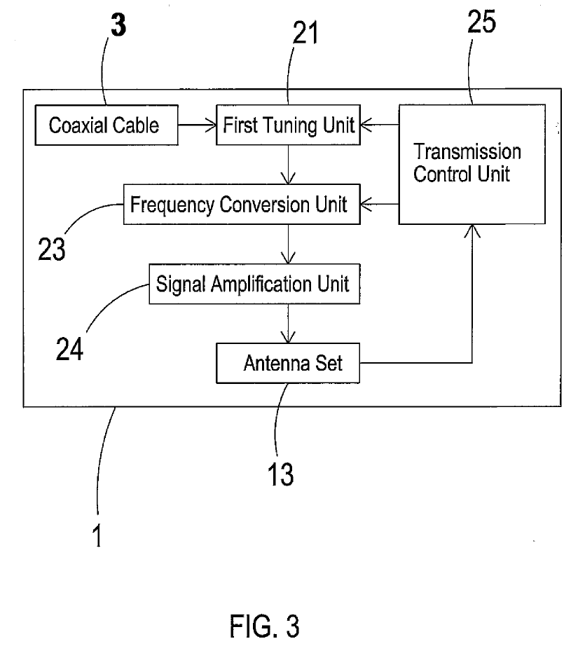

Referring to FIG. 3, it shows a block diagram of an emitter of the present invention. The emitter 1 is connected with the coaxial cable 3 and the antenna set 13. A cable TV or a satellite TV signal coming from the coaxial cable 3 can be transmitted to the receiver 4 wirelessly by the emitter 1. The receiver 4 receives the signal through the antenna set 42, demodulates the signal and then transmits it through various interfaces to a corresponding displayer to display. The emitter 1 includes the first tuning unit 21, the frequency conversion unit 23, a signal amplification unit 24 and a transmission control unit 25. The first tuning unit 21 in the emitter 1 receives the signal coming from the coaxial cable 3, and sends the signal to the frequency conversion unit 23 for frequency conversion. After up-conversion, the signal is amplified through the signal amplification unit 24 and transmitted to the antenna set 13 for wireless transmission. At a same time, the transmission control unit 25 receives the control signals from the antenna set 13 to perform control functions, such as TV channel selection, turning on or off wireless transmission, etc.

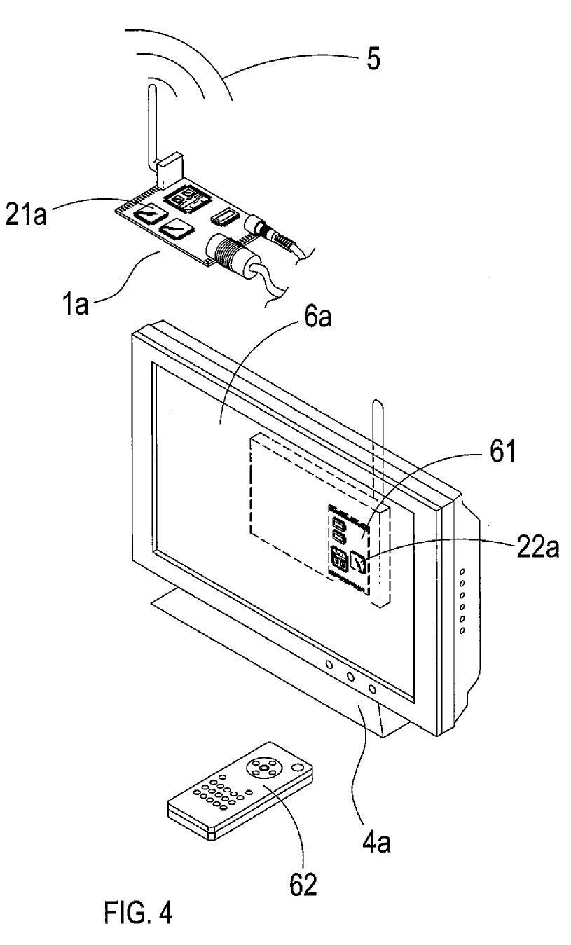

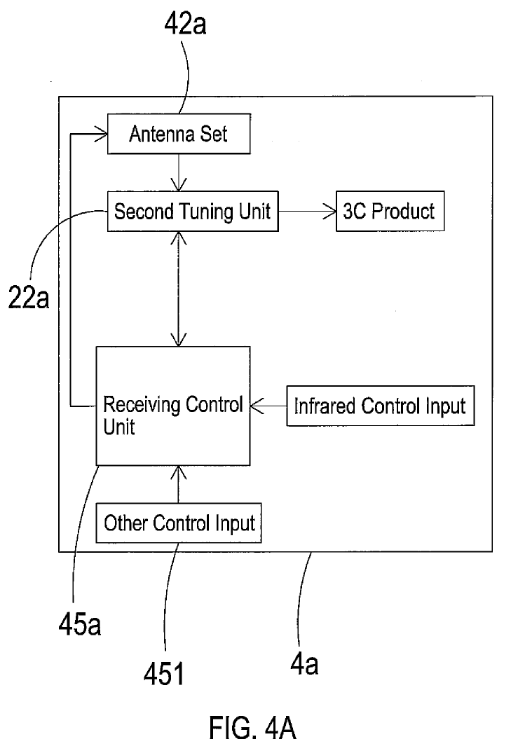

Referring to FIG. 4 and FIG. 4A at a same time, it shows a schematic view of an implementation and a block diagram of a receiver, of a preferred embodiment of the present invention. An emitter 1a is provided with a first tuning unit 21a, and a receiver 4a is provided with a second tuning unit 22a and is a TV set 6a. As the second tuning unit 22a is compatible with a control board 61 in the TV set 6a, the second tuning unit 22a can be built into the control board 61 of the TV set 6a, and can replace the tuning unit in the original TV set 6a. The second tuning unit 22a can be compatible with a digital interface or an analog interface. When we use the present invention, the first tuning unit 21a in the emitter 1a will transmit a signal 5 to the second tuning unit 22a in the control board 61 of the TV set 6a. At this time, a user can directly use a remote controller 62 of the TV set 6a to remotely control channels of the TV set 6a, without externally connecting a Set-Top box of a cable TV, thereby saving space and being pretty, as well as avoiding trouble in wire layout, as wireless transmission is used.

Accordingly, as described above, when the receiver 4a receives the signal, the signal is received through an antenna set 42a and is then filtered by the second tuning unit 22a. In a mean time, the frequency is adjusted to fit into one of channel frequencies and then the TV from wireless path is watched through the TV set 6a. The receiver 4a is also provided with a receiving control unit 45a which can receive other control signal 451 (such as channel selection or turning on and off, etc.) emitted by the user, so as to transmit back the control signal emitted by the user to the emitter 1a.

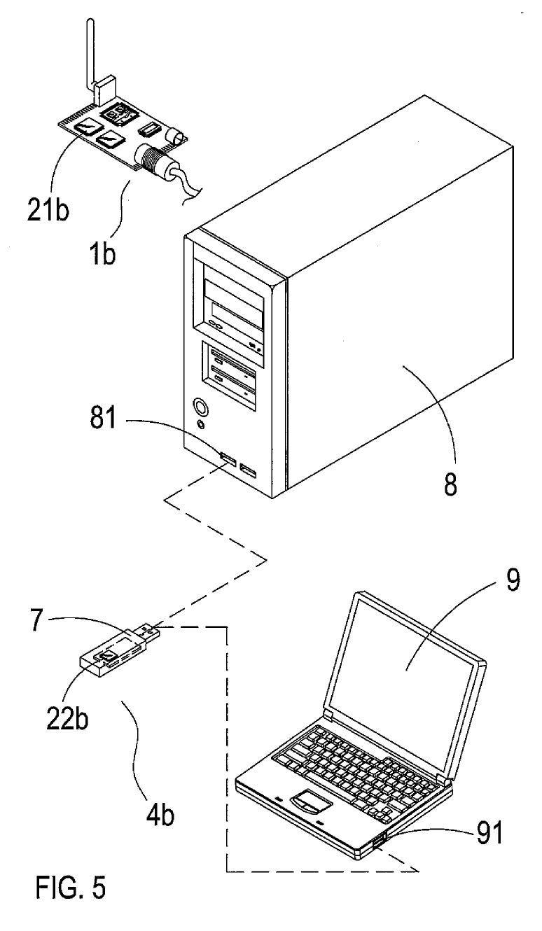

Referring to FIG. 5, it shows a schematic view of an implementation of a first preferred embodiment of the present invention. When a receiver 4b is a USB device 7, a first tuning unit 21b is provided in an emitter 1b, and a second tuning unit 22b is provided in a receiver 4b. The USB device 7 can be compatible with a USB slot 81 of a desktop computer 8 and a USB slot 91 of a laptop computer 9, such that when the user is to use the desktop computer 8 or the laptop computer 9 to watch a TV program, he or she only needs to insert the USB device 7 into the desktop computer 8 that is provided with the USB slot 81 or into the laptop computer 9 that is provided with the USB slot 91. By using the present invention, we can watch the cable TV programs on the desktop computer 8 or the laptop computer 9 without purchasing a Set-Top box. Users can save a lot of budgets, avoid trouble of many wire layouts, and save a lot of space. Moreover, as shown in FIG. 4A, the aforementioned USB device 7 is also provided with the antenna set 42a and the receiving control unit 45a.

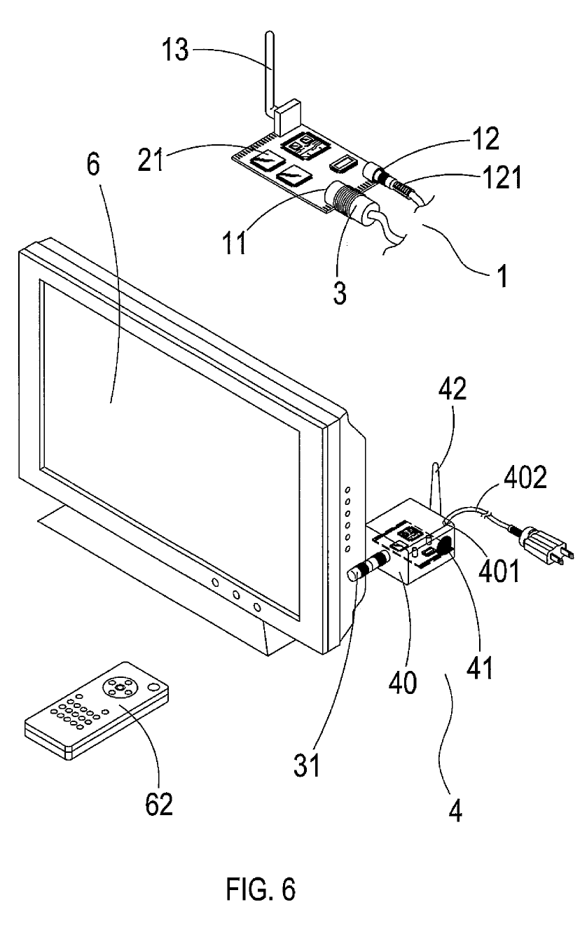

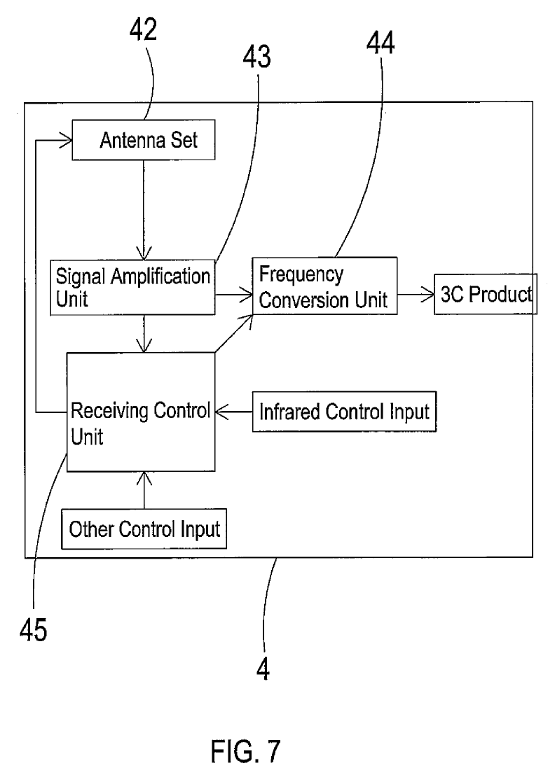

Referring to FIG. 6, it shows a schematic view of an implementation of a second preferred embodiment of the present invention. The first tuning unit 21 is provided in the emitter 1, and the emitter 1 includes the F-type connector 11 and the power hole 12. The F-type connector 11 is connected with the coaxial cable 3 by which the cable TV signal can be transmitted to the emitter 1. In addition, the power hole 12 is connected with an electric line 121 to power the emitter 1. The receiver 4 is in a housing 40, one side of which is provided with an infrared receiver 41 to receive the control signals from the remote controller 62. The housing 40 can be externally connected to a TV set 6 and is provided with a second power hole 401. The second power hole 401 is connected with a second power line 402 to power the receiver 4. The receiver 4 is provided with the antenna set 42 which is a dual band antenna. The antenna set 42 wirelessly receives or transmits the signal from or to the emitter 1 and transmits or receives to or from the receiver 4. By the aforementioned structures, when the user is to use the present invention, he or she only needs to connect the housing 40 with a coaxial cable 31 of the TV set 6, then the first tuning unit 21 in the emitter 1 will send the signal through the antenna set 13 to the antenna set 42 of the housing 40. The signal received by the antenna set 42 is sent to a signal amplification unit for amplification, and is converted to one of TV channel frequencies through a frequency conversion unit. Therefore, the TV set 6 can be used to watch the cable channels through wireless transmission, which is very convenient. In addition, when the user is to select a TV channel, the receiver 4 will transmit back a control signal through the antenna set 42 to the antenna set 13 of the emitter 1 for reception, such that the user can successfully switch the TV channel at any time. Referring to FIG. 7 at a same time, it shows a block diagram of an external receiver of the present invention. The receiver 4 receives the signal through the antenna set 42 and includes a signal amplification unit 43, a frequency conversion unit 44 and a receiving control unit 45. After being received by the signal amplification unit 43, the signal is amplified and the frequency of the signal is then converted through the frequency conversion unit 44 to a channel frequency which can be received by a TV. Furthermore, when the user sends a control signal to the receiving control unit 45, the receiving control unit 45 will transmit the control signal back to the emitter 1; the receiving control unit 45 can be further added with an automatic scanning function.

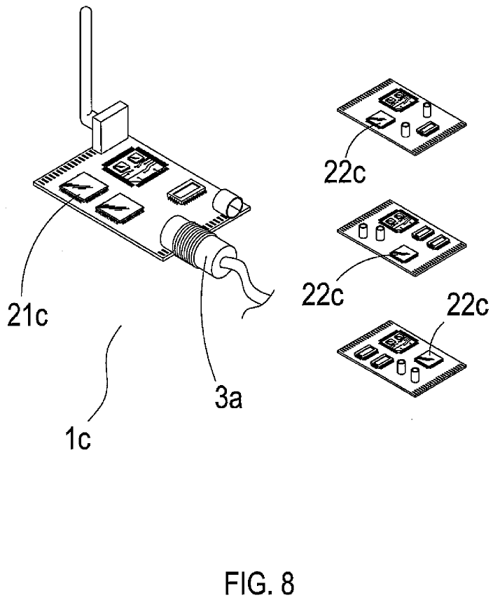

Referring to FIG. 8 at a same time, it shows a schematic view of an implementation of a third preferred embodiment of the present invention. The present invention comprises an emitter 1c, more than one first tuning unit 21c and more than one second tuning unit 22c. The emitter 1c is connected with a coaxial cable 3a to receive TV signals of a cable TV. The first tuning units 21c are installed in the emitter 1c, and the second tuning units 22c are installed respectively in all kinds of 3C products having a display unit. When the user is to use the present invention to watch TV programs, the first tuning units 21c will send the signal to the second tuning units 22c. By the aforementioned structures, the wireless transmission function of the present invention is achieved. In a mean time, the cable TV programs can be watched and the TV channel can be switched at any time on another 3C product having the display unit.

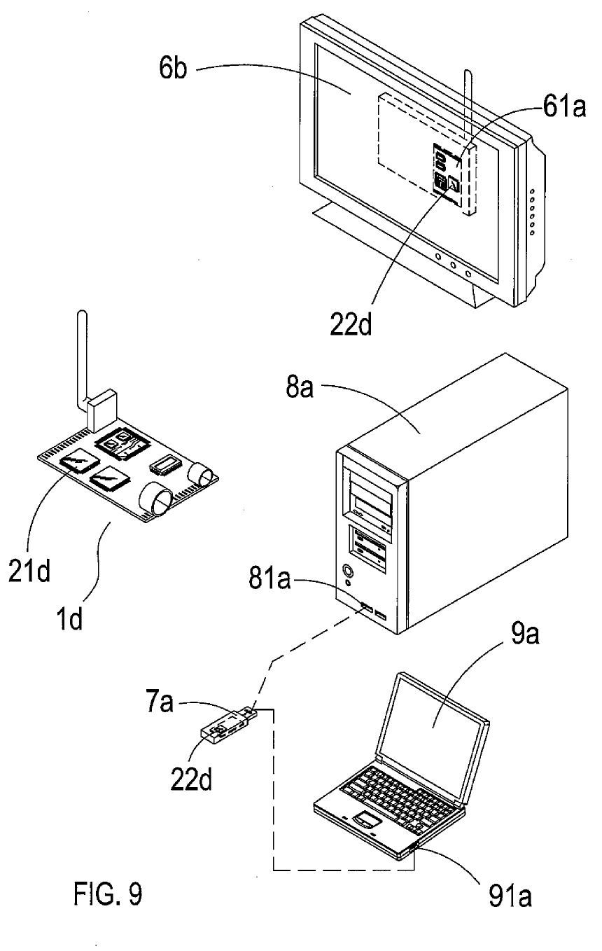

Referring to FIG. 9 at a same time, it shows a schematic view of an implementation of a fourth preferred embodiment of the present invention. An emitter 1d is provided with plural first tuning units 21d, and second tuning units 22d are provided on a control board 61a of a TV set 6b and in a USB device 7a. The USB device 7a can be connected with a USB slot 81a of a desktop computer 8a and a USB slot 91a of a laptop computer 9a, such that when the user is to use the desktop computer 8a, the laptop computer 9a or the TV set 6b to watch the cable TV programs, the first tuning units 21d will transmit the signals through the emitter 1d to the second tuning unit 22d in the control board 61a of the TV set 6b and the second tuning unit 22d in the USB device 7a. The second tuning units 22d receive the signal, adjust a band and display on screens, allowing the users to watch different cable TV programs in different displays at a same time. This invention, which is provided with the advantage of low cost, can save the time and money to lay out wires in a room.

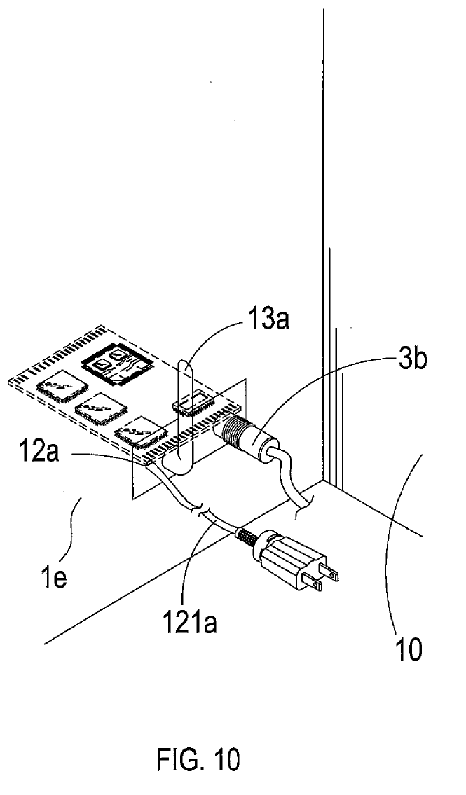

Referring to FIG. 10, it shows a schematic view of an implementation of a fifth preferred embodiment of the present invention. An emitter 1e can be further embedded in a wall 10, and is provided with an antenna set 13a, an F-type connector 11a and a power hole 12a, at an exterior side of the wall 10. The F-type connector 11a is connected with a coaxial cable 3b which provides a signal to the emitter 1e. The power hole 12a is connected with an electric element 121a which provides necessary electricity to the emitter 1e.

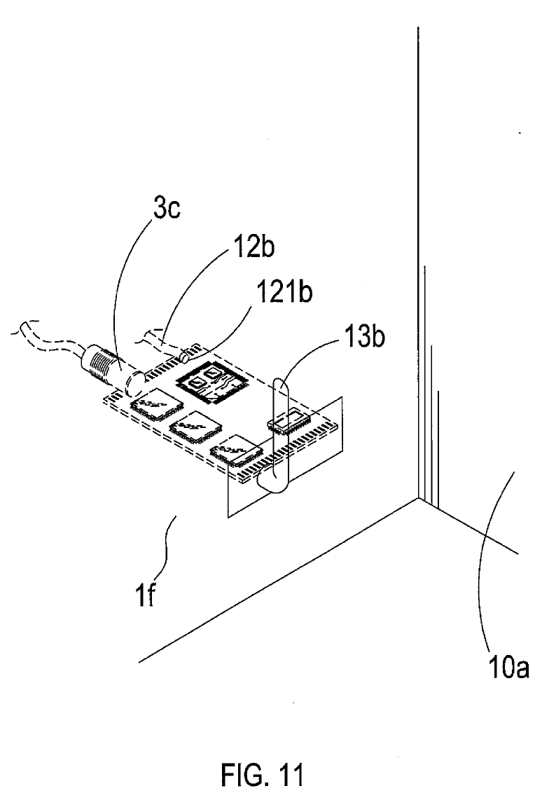

Referring to FIG. 11, it shows a schematic view of an implementation of a sixth preferred embodiment of the present invention. An emitter 1f can be further embedded in a wall 10a and is provided with an antenna set 13b at an exterior side of the wall 10a. In addition, the emitter 1f is provided with an F-type connector 11b and a power hole 12b at an interior side of the wall 10a. The F-type connector 11b is connected with a coaxial cable 3c which provides a signal to the emitter 1f and the power hole 12b is connected with an electric element 121b which provides necessary electricity to the emitter 1f.

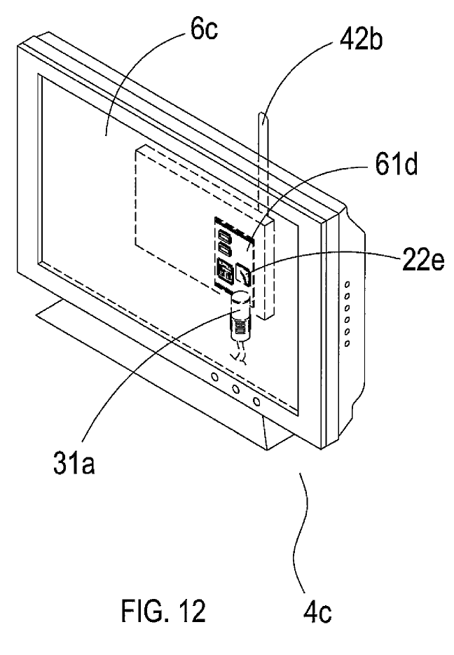

Referring to FIG. 12, it shows a schematic view of an implementation of a seventh preferred embodiment of the present invention. A receiver 4c is a TV set 6c and is provided with a second tuning unit 22e which can be compatible with a control board 61b of the TV set 6c. The second tuning unit 22e is connected with an antenna set 42b and a coaxial cable 31a connecting to terrestrial antenna. The users can select the TV program from cable TV through wireless connection or terrestrial antenna from TV controller. In addition, when the wireless transmission is failed due to the environment limitation, users can replace wireless antenna by TV cable for continuing program watching.

Referring to all the drawings, the present invention, when in use, is actually provided with following advantages, in comparison with the prior art:
1. When using the present invention, the user only needs to install the emitter 1 on the coaxial cable 3, and the receiver 4 on the TV set 6 or to build the second tuning unit 22 into the control board 61 of the TV set 6, that he or she can watch the cable TV programs. The installation is easy and the cost is low. In addition, there is no need to layout the wires that more space in a room can be used flexibly and is also prettier.
2. The second tuning unit 22b of the present invention can be also built into the USB device 7, such that when the user is to use the desktop computer 8 or the laptop computer 9 to watch the cable channels, he or she can directly insert the USB device 7 that is provided with the second tuning unit 22b into the USB slot 81 of the desktop computer 8 or the USB slot 91 of the laptop computer 9 that the aforementioned computers can be used to watch the cable TV programs.
3. If the cable TV is to be expanded, then only the branched-out TV set 6b, the desktop computer 8a and the laptop computer 9a need to be installed with the second tuning units 22d of the present invention that the cable channels can be watched, without purchasing additional splitters and coaxial cables and avoiding the trouble in laying out the wires, thereby achieving the practical progressiveness of saving cost of materials and a lot of space.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A radio tuning device through a cable, which transmits an image signal wirelessly to a player, comprising an emitter which is connected with a coaxial cable and an interior of which is provided with a first tuning unit; and more than one receiver which is electrically connected to a 3C (computer, communication, consumer electronics) product and transmits a wireless signal to the emitter, the receiver being built into the 3C product with a display unit.

2. The radio tuning device through a cable, according to claim 1, wherein the emitter is further provided with a frequency conversion unit, a signal amplification unit and a transmission control unit.

3. The radio tuning device through a cable, according to claim 1, wherein the receiver is further provided with a second tuning unit, a signal amplification unit, a frequency conversion unit and a receiving control unit.

4. The radio tuning device through a cable, according to claim 1, wherein the 3C product is a TV (television) set.

5. The radio tuning device through a cable, according to claim 1, wherein the emitter is provided with an F-type connector at a pre-determined proper position.

6. The radio tuning device through a cable, according to claim 1, wherein the first tuning unit and the second tuning unit are applied to a digital interface or an analog interface.

7. The radio tuning device through a cable, according to claim 3, wherein the first tuning unit and the second tuning unit are applied to a digital interface or an analog interface.

8. The radio tuning device through a cable, according to claim 1, wherein the emitter is embedded in a wall.

9. The radio tuning device through a cable, according to claim 1, wherein the coaxial cable is built into the wall or connected externally at an exterior side of the wall.

10. The radio tuning device through a cable, according to claim 7, wherein the coaxial cable is built into the wall or connected externally at an exterior side of the wall.

11. The radio tuning device through a cable, according to claim 1, wherein the receiver is further a PCMCIA (Personal Computer Memory Card International Association) interface card or a USB (Universal Serial Bus) device.

12. The radio tuning device through a cable, according to claim 1, wherein the receiver is further combined with a DVI (Digital Video Interface) interface, a VGA (Video Graphics Array) interface or an HDMI (High-Definition Multimedia Interface).
